(19) United States
(12) Patent Application Publication
(10) Pub. No.: US 2005/0119360 A1
(43) Pub. Date: Jun. 2, 2005

(54) Method for producing porous material

(75) Inventors: Nobuyuki Kawakami, Kobe-shi (JP); Takayuki Hirano, Kobe-shi (JP); Yoshito Fukumoto, Kobe-shi (JP)

Correspondence Address: REED SMITH LLP, SUITE 1400, 3110 FAIRVIEW PARK DR., FALLS CHURCH, VA, 22042, US

(73) Assignee: Kabushiki Kaisha Kobe Seiko Sho

(21) Appl. No.: 10/995,234

(22) Filed: Nov. 24, 2004

(30) Foreign Application Priority Data
Nov. 28, 2003 (JP) 2003-398356
Feb. 23, 2004 (JP) 2004-045565

(51) Int. Cl. C08J 9/00

(52) U.S. Cl. 521/77

(57) ABSTRACT

A method for producing a porous material exhibiting temporal stability includes the step of forming a primary material containing a matrix precursor for forming the matrix of the porous material and a porogen for forming pores; the step of removing the porogen from the primary material to form reactive sites exposed at the surface of the matrix; and the step of reacting the reactive sites with an inactivation promoter to inactivate the reactive sites. For a porous material hard to shrink even after heat treatment, the method includes the step of forming a primary material including a matrix formed of a matrix precursor and a pore-forming portions formed of a porogen; the step of supplying an additional matrix precursor for growing the matrix, dissolved in a supercritical or subcritical fluid; and the step of removing the porogen from the pore-forming portions.

### BACKGROUND OF THE INVENTION

1. Field of the Invention

The present invention relates to porous materials used for dielectric layers of high-frequency circuits, insulating interlayers of semiconductor integrated circuits including large-scale integrated circuits (LSIs), catalysts, solid electrolytes, electron emitting devices, optical devices, and so forth, and to method for producing the same.

2. Description of the Related Art

Insulating films mainly containing SiO₂ are broadly used as insulating interlayers in semiconductor devices and other devices. Although SiO₂ has a comparatively low relative dielectric constant of 3.9, a still lower dielectric constant is desired for progress of semiconductor integration or multilayering. A relative dielectric constant of 2.0 or less has recently been desired.

In order to achieve a relative dielectric constant of 2.0 or less, the material has to have a low density, and accordingly be porous. Unfortunately, as the density is reduced, the mechanical strength of the material is, in general, significantly degraded. This is because pores formed to reduce the density are nonuniformly dispersed in the material. In order to maintain the strength even if the density is reduced, it is advantageous to realize a highly regular or periodic structure, such as honeycomb.

In order to produce a porous material having a regular or periodic porous structure, U.S. Pat. No. 5,958,577 has disclosed a method in which alkoxysilane, water, and a surfactant are blended and allowed to react to prepare a silica/surfactant composite, followed by aging, drying, and calcination. For the formation of a porous thin film having a periodic structure, European Patent No. 739856 has disclosed a method in which tetraalkoxysilane is hydrolyzed in the presence of an acid and subsequently mixed with a surfactant, and the resulting solution is applied onto a base material and dried to form a silica-surfactant nanocomposite, followed by calcination.

These methods disadvantageously require the step of calcining the surfactant, which is a porogen for the porous structure, at a high temperature of at least 500° C. The methods cannot therefore be applied to the formation of insulating interlayers of semiconductor devices.

U.S. Pat. No. 6,423,770 has disclosed a method capable of forming a porous material at low temperature. In the method, a non-silicate constituent is extracted from a material composed of a silicate region and non-silicate regions by solvent exchange or fluid exchange to produce a porous silicate. For the extraction, the method also uses a supercritical fluid. As broadly known, processes using a supercritical fluid make very small the deformation of the material from which a solvent is extracted because capillary shrinkage force does not occur in the processes. An example of U.S. Pat. No. 6,423,770 uses a supercritical fluid comprising isopropyl alcohol alone.

It is known that a supercritical medium contains a solvent missible with the object to be extracted, as disclosed in U.S. Patent Application publication No. 2003/0008155.

It is also known that porous material is hygroscopic, and accordingly liable to deteriorate with time disadvantageously. To overcome this disadvantage, U.S. Pat. No. 5,496,527 and Japanese Unexamined Patent Application Publication No. 2003-119052 have disclosed a method in which the porous material is stabilized by hydrophobic treatment and a method in which the hydrophobic treatment is performed in a supercritical fluid.

The inventors of the present invention observed a porous material from which the porogen had been extracted with a supercritical fluid, and found that the thickness of the resulting porous material gradually decreased with time. The decrease in thickness results in a disadvantage that no desired structure or properties can be obtained. In the above-cited U.S. Pat. No. 5,496,527 and Japanese Unexamined Patent Application Publication No. 2003-119052, the hydrophobic treatment is performed as aftertreatment on a porous material in which pores have been completely formed, and they do not intend to stabilize the porous material in the step of forming the pores.

A sol-gel method has been known for producing a porous material having a regular matrix structure. For example, U.S. Pat. No. 5,958,577 has disclosed a method in which a matrix precursor alkoxysilane, water, and a surfactant serving as a porogen are blended and allowed to react to prepare a silica/surfactant composite (primary material) including a matrix formed of silica (matrix precursor) and a pore-forming portions formed of the surfactant, followed by aging, drying, and calcination. Also, in the above-cited European Patent No. 739856, tetraalkoxysilane is hydrolyzed in the presence of an acid and subsequently mixed with a surfactant, and the resulting solution is applied onto a base material and dried to form a silica-surfactant nanocomposite (primary material), followed by calcination at 500° C. Thus, a porous thin film having a periodic structure is formed.

In the above-cited U.S. Pat. No. 6,423,770, the non-silicate constituent is extracted from the material composed of the silicate region and the non-silicate regions by solvent exchange or fluid exchange, thereby preventing the shrinkage and deformation of the matrix. For the extraction, the method uses a supercritical fluid. As described above, processes using supercritical fluid make very small the deformation of the material from which a solvent is extracted because capillary shrinkage force does not occur in the processes.

While removal of the porogen by extraction using a supercritical fluid prevents the shrinkage and deformation resulting from calcination at high temperature, some cases require low temperature heat treatment of the porous material at about 200° C. to stabilize the resulting porous material, after the removal of the porogen. However, even if such low temperature heat treatment is performed, shrinkage still occurs in the porous material. This is because the matrix of the porous material does not closely contain its constituents, and hence, it is microscopically porous. More specifically, if the microscopically porous matrix is heated, the microscopic pores are easily clogged, and thus shrinkage occurs in the porous material. This is similar to the phenomenon in which the density of ceramic material is increased by annealing.

Mat. Res. Soc. Proc. vol. 716,2002 Materials Research Society, p. 587 (Y. Oku et al.) has proposed a method for preventing the matrix from shrinking during high-temperature calcination, by increasing the density of the matrix of the primary material of the porous material. In the method, a matrix precursor tetraethoxysilane (TEOS) is subjected to vapor permeation after the formation of the primary material and before the removal of the porogen at high temperature. Unfortunately, in order to evaporate TEOS and efficiently introduce the matrix precursor into the matrix of the primary material effectively, this method also requires the primary material to be exposed to a heating atmosphere at about 200° C.

The above-described vapor permeation treatment is effective at preventing the shrinkage of the matrix of the primary material. However, a temperature history of about 200° C. occurs during the treatment, and inevitably causes shrinkage. Thus, shrinkage is not sufficiently prevented.

### SUMMARY OF THE INVENTION

Accordingly, an object of the present invention is to provide a method for producing a porous material and which enhances the temporal stability of the porous material from which the porogen has been extracted, and the porous material having superior temporal stability. Another object of the present invention is to provide a method for producing a porous material in which the density of the matrix of a primary material is increased during the production process without shrinkage as much as possible, and the porous material produced by the method. The resulting porous material is difficult to shrink even if heat treatment is applied.

The inventors of the present invention have found that changes in size of a porous material with time are caused by the following reasons. A surfactant serving as the porogen, which is to be extracted, forms a micelle, as shown in FIG. 1. The micelle is coupled with a matrix (silica matrix in the figure) formed around the micelle, by an attractive force resulting from electrical polarity or the like. The extraction of the surfactant with a supercritical fluid is achieved by a force stronger than the attractive force, drawing the molecules of the surfactant to separate from the silica matrix into the supercritical fluid. The silica matrix separated from the surfactant molecules has an electrically imbalanced voids or pores, and thus reactive sites are formed at the surface defining the voids, or the internal surface of the matrix, as shown in FIG. 2. FIG. 2 shows the reactive sites by Si—O— and Si—OH. The Si—O— is easily turned into Si—OH with water in environment. Since the reactive sites are energetically unstable, they can be easily bonded with their adjacent reactive sites according to the following equation:
(Si—OH)+(HO—Si)→(Si—O—Si)+(H₂O)

This reaction is dehydration polymerization, and forms the silica matrix, while reducing the volume of the silica matrix. Consequently, the volume of the porous material is reduced. Hence, the reduction in thickness with time is caused by the dehydration polymerization. Therefore, by preventing the dehydration polymerization at the reactive sites of the internal surface of the matrix, the porous material can be prevented from shrinking with time. The present invention has been accomplished on the basis of the above-described findings.

According to an aspect of the present invention, a method for producing a porous material is provided which includes: the primary material forming step of forming a primary material containing a matrix precursor for forming a matrix of the porous material and a porogen for forming pores; the removal step of removing the porogen from the primary material to form pores, thereby exposing reactive sites at the surface of the matrix; and the inactivation step of reacting the reactive sites with an inactivation promoter to inactivate the reactive sites. The inactivation promoter comprises a compound having a functional group reactive with the reactive sites of the matrix and a functional group stable in itself.

Preferably, the unreactive functional group of the inactivation promoter is a hydrophobic group.

Since the method performs the inactivation step of inactivating the reactive sites exposed at the surface defining the pores of the matrix by removing the porogen, in addition to the removal step, the reactive sites can be inactivated so that the surface of the matrix is stabilized. Thus, the temporal stability of the resulting porous material can be enhanced.

In the known methods disclosed in the foregoing U.S. Pat. No. 5,496,527 and Japanese Unexamined Patent Application Publication No. 2003-119052, the pores formed in the process are exposed to the atmosphere before inactivation. On the other hand, the method of the present invention prevents the pores from being exposed to the atmosphere, so that the matrix of the porous material does not adsorb water.

The inactivation step may be performed after the removal step is completely performed on the entire primary material. Alternatively, the inactivation promoter may be supplied to the primary material before the removal step is completed for the entire primary material so that the removal step and the inactivation step are performed in parallel.

By simultaneously performing the removal step and the inactivation step, productivity is increased, and the reaction among the reactive sites can be prevented with reliability. Thus, a porous material having more superior temporal stability can be provided.

Preferably, the inactivation step is performed immediately after the completion of the removal step, that is, almost simultaneously with the completion of removal of the porogen. Thus, the reactive sites are inactivated without reacting with their adjacent reactive sites to further increase the stability.

Preferably, the reaction between the reactive sites and the inactivation promoter is performed by derivatization, thereby efficiently inactivating the reactive sites. The derivatization herein refers to a reaction substituting a desired functional group for a functional group exposed at the surface of a material. Preferably, a hydrophobic group is substituted for a hydrophilic group of the matrix.

Preferably, the removal step uses a supercritical fluid to remove the porogen, and the inactivation step is performed by a mixture of the supercritical fluid and the inactivation promoter.

By using a supercritical fluid in the removal step and the inactivation step, the method can efficiently remove the porogen, taking advantage of the high density, high diffusibility, and low viscosity of the supercritical fluid. Also, by mixing the inactivation promoter with the supercritical fluid, the inactivating promoter can easily reach the pores, thereby achieving the inactivation effectively.

Preferably, the mixture further contains a mixing promoter missible with the inactivation promoter and the supercritical fluid. Thus, the inactivation promoter can be evenly blended into the supercritical fluid to enhance the inactivating ability. Preferably, the mixing promoter is an organic solvent because the inactivation promoter is generally an organic compound. The inactivation promoter content in the mixture is appropriately set in such a range that the inactivation promoter is evenly blended into the supercritical fluid without adversely affecting the inactivation ability, and preferably it is 50% by volume or less relative to the mixing promoter content.

Preferably, the supercritical fluid mainly contains carbon dioxide and/or at least one alkyl alcohol. Any of these compounds is missible with various types of material.

Preferably, the porogen is an organic compound from the viewpoint of easily dispersing in the matrix precursor. More preferably, the porogen is an organic surfactant because the surfactant can form a micelle resulting in regularly arranged pores, in the matrix precursor. By removing the porogen, a regular or periodic porous structure is easily provided, and thus the mechanical strength of the porous structure is enhanced.

The matrix precursor is preferably an inorganic material from the viewpoint of thermal stability, workability, and mechanical strength. In particular, silica-based materials are suitable because of their low dielectric constant.

The inactivation promoter may be a derivatization agent.

Since the method performs the inactivation step of inactivating the reactive sites exposed at the surface of the matrix by removing the porogen, in addition to the removal step, the reactive sites can be inactivated so that the surface of the matrix is stabilized. Thus, the temporal stability of the resulting porous material can be enhanced.

According to another aspect of the present invention, a method for producing a porous material is provided which includes: the primary material forming step of forming a primary material including a matrix formed of a matrix precursor and a pore-forming portions formed of a porogen; the matrix precursor addition step of supplying an additional matrix precursor for growing the matrix, dissolved in a supercritical or subcritical fluid; and the removal step of removing the porogen from the pore-forming portions.

The additional matrix precursor has a functional group reactive with the surface of the matrix and an atomic bond forming the matrix. Such a compound easily bonds to the surfaces defining microscopic pores in the matrix in the primary material and combines with the matrix to increase the density of the matrix.

The compound having the atomic bond forming the matrix refers to a compound having a molecular structure capable of forming the matrix. For example, it the matrix is formed by Si—O bonds, the atomic bond forming the matrix may be a Si—O—R(R: organic functional group). Since such a compound includes the Si—O bond, it can be a matrix.

Since, in the method, the additional matrix precursor growing the matrix dissolved in a supercritical or subcritical fluid is supplied to the primary material, the matrix is formed with a material exhibiting extremely high kinetic energy and diffusibility even at a temperature as low as about 150° C. or less. Thus, the additional matrix precursor can be easily supplied to an infinite number of the microscopic pores in the matrix. Consequently, the matrix precursor can be easily taken in the microscopic pores in the matrix to form a microscopically dense matrix structure. The resulting matrix is thus prevented from shrinking as much as possible, even if heat treatment is applied in a subsequent step, and the resulting porous material exhibits high dimensional and profile accuracy. The subcritical fluid herein refers to a fluid having a temperature of 0.9×Tc (critical temperature) and a pressure of 0.9×Pc (critical pressure).

Preferably, the removal step is performed in a supercritical fluid or a subcritical fluid. The supercritical or subcritical fluid may be the supercritical or subcritical fluid used in the matrix precursor addition step. Thus, an efficient production process exhibiting high throughput can be achieved, including the matrix precursor addition step and the removal step.

Preferably, the supercritical or subcritical fluid containing the additional matrix precursor further contains a mixing promoter missible with the additional matrix precursor and the fluid. The use of the mixing promoter helps blend the additional matrix precursor evenly into the supercritical or subcritical fluid, thus promoting the supply of the additional matrix precursor to the matrix in the primary material. Preferably, the mixing promoter is an organic solvent. The additional matrix precursor content in the mixture is appropriately set in such a range that the matrix precursor is evenly blended into the supercritical fluid without adversely affecting the ability of the matrix precursor, and preferably it is about 50% by volume or less relative to the mixing promoter content.

Preferably, the supercritical or subcritical fluid mainly contains carbon dioxide, an alkyl alcohol, or carbonized hydrogen fluoride, or a mixture of at least two of these compounds. Such a supercritical or subcritical fluid can be prepared at 150° C. or less, preferably 100° C. or less, and be missible with various types of material.

Preferably, the porogen is an organic compound from the viewpoint of easily dispersing in the matrix precursor. More preferably, the porogen is an organic surfactant because the surfactant can form a micelle resulting in regularly arranged pores, in the matrix precursor. By removing the porogen, a regular or periodic porous structure is easily provided, and thus the mechanical strength of the porous structure is enhanced.

The matrix precursor is preferably an inorganic material from the viewpoint of thermal stability, workability, and mechanical strength. In particular, silica-based materials are suitable because of their low dielectric constant.

The functional group reactive with the surface of the matrix is preferably a reactive alkoxy group, and the additional matrix precursor having an alkoxy group may be a metal alkoxide.

In the method, an infinite number of microscopic pores in the matrix are filled with the additional matrix precursor to increase the density of the matrix in the matrix precursor addition step. Therefore, the resulting matrix is difficult to shrink, and thus the resulting porous material exhibits high dimensional and profile accuracy.

In the method according to the second aspect, since the microscopic pores in the matrix is filled to increase the density of the matrix in the primary material in the matrix precursor addition step, the resulting matrix is difficult to shrink. Thus, a porous material exhibiting high dimensional and profile accuracy can be provided.

### BRIEF DESCRIPTION OF THE DRAWINGS

FIG. 1 is a schematic illustration of a part of a silica matrix formed around a micelle constituted of the molecules of a surfactant;

FIG. 2 is a schematic illustration of a surface of the silica matrix defining a pore formed by removing the molecules of the surfactant; and

FIG. 3 is a schematic diagram of the entire arrangement of a removing and inactivating apparatus used in an embodiment of the present invention.

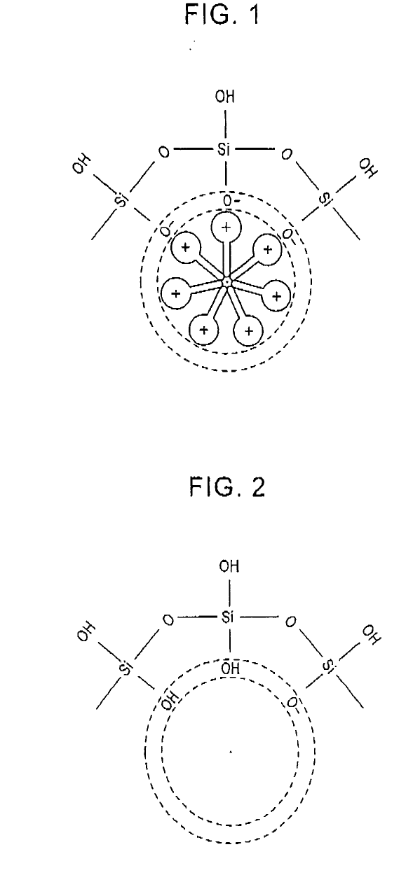

### DESCRIPTION OF THE PREFERRED EMBODIMENTS

A method for producing a porous material according to a first embodiment of the present invention will now be described.

The method for producing the porous material according to the present invention includes the following three steps; (1) the primary material forming step of forming a primary material containing a matrix precursor for forming the matrix of the porous material and a porogen for forming pores; (2) the removal step of removing the porogen from the primary material to form reactive sites exposed at the surface of the matrix; and (3) the inactivation step of reacting the reactive sites with an inactivation promoter to inactivate the reactive sites.

Preferably, the inactivation step is performed immediately after the step of the removal step. Thus, the reaction between the adjacent reactive sites formed after the removal of the porogen can be prevented as much as possible. Preferably, the reaction of the reactive sites with the inactivation promoter is performed by efficient derivatization.

For removing the porogen and inactivating the reactive sites, a supercritical fluid permeable to microstructures is preferably used. Preferably, the supercritical fluid mainly contains carbon dioxide and/or at least one alkyl alcohol, which are missible with various types of material.

In the removal step, use of a mixture of carbon dioxide and an alkyl alcohol as the supercritical fluid is effective at dissolving and extracting the porogen, which is organic, rather than the use of carbon dioxide alone. In addition, the alkyl alcohol in the supercritical fluid can serve as a mixing promoter, as described later, to help the supercritical fluid dissolve the inactivation promoter.

The inactivation step may also use a supercritical fluid. In this instance, an inactivation promoter is supplied to the supercritical fluid used in the removal step to prepare a supercritical fluid containing the inactivation promoter, after the removal of the porogen. Thus, the inactivation promoter can be deeply supplied to the pores immediately after removal of the porogen, thereby promoting inactivation of the reactive sites at the surface of the matrix.

The inactivation promoter may be a compound having both functional groups reactive and unreactive with the reactive sites of the matrix. Examples of such reactive functional groups include halogen, amino, imino, carboxyl, and alkoxyl. The unreactive functional group is preferably a hydrophobic group, and examples of such groups include alkyl, phenyl, and their fluorides. Derivatization agents can be used as the inactivation promoter, including silanes such as silane couplers, silylation reagents, and functional silanes. Although alcohols, ketones, and amides, which can be used as the mixing promoter described later, exhibit an inactivating effect under heating conditions, the effect is small, and these materials are not used as the inactivation promoter.

Exemplary silane couplers include vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmuethyldiethoxysilane, 3-methacryloxypropyltriethoxysilane, 3-acryloxypropyltrimethoxysilane, 3-(2-aminoethylaminopropyl)trimethoxysilane, 3-aminopropyltriethoxysilane, 3-chloropropyltrimethoxysilane, 3-aminopropyltrimethoxysilane, N-2(aminoethyl)-3-aminopropylmethyldimethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-trichloropropyltrimethoxysilane, 3-mercaptopropylmethyldimethoxysilane, 3-mercaptopropyltrimethoxysilane, bis(triethoxysilylpropyl)tetrasulfide, and 3-isocyanatepropyltriethoxysilane.

Exemplary silylation reagents include trimethylchlorosilane, hexamethyldisilazane, triethylchlorosilane, trimethylsilyl trifluoromethanesulfonate, N,O-bis(trimethylsilyl)acetamide, N,O-bis(trimethylsilyl)trifluoroacetamide, N-methyl-N-(trimethylsilyl)trifluoroacetamide, N-methyl-N-tert-butyl(dimethylsilyl)trifluoroacetamide, N-trimethylsilylimidazole, tert-butyldimethylchlorosilane, N,N-bis(trimethylsilyl)urea, and 1,1,3,3-tetraisopropyl-1,3-dichlorodisiloxane.

Exemplary functional silanes include hexamethyldisiloxane, trimethylmethoxysilane, trimethylmethoxysilane, trimethylmethoxysilane, triethylethoxysilane, dimethyldimethoxysilane, dimethyldiethoxysilane, diethyldimethoxysilane, diethyldiethoxysilane, diphenyldirnethoxysilane, diphenyldiethoxysilane, methyltrimethoxysilane, methyltriethoxysilane, ethyltrimethoxysilane, ethyltriethoxysilane, phenyltrimethoxysilane, phenyltriethoxysilane, hexyltrimethoxysilane, hexyltriethoxysilane, decyltrimethoxysilane, decyltriethoxysilane, 3,3,3-trifluoropropyltrimethoxysilane, heptadecatrifluorodecyltrimethoxysilane, dimethyldichlorosilane, methyltrichlorosilane, ethyltrichlorosilane, fluorooctylethyltrimethoxysilane, heptadecafluorodecyltrichlorosilane, allyltrichlorosilane, allyltriethoxysilane, allyltrimethylsilane, 1,3-bis(chloromethyl)-1,1,3,3-tetramethyldisilazane, 1,2-bis(dimethylchlorosilyl)ethane, bis(trimethylsilyl)acetylene, n-butyltrichlorosilane, chloromethyldimethylchlorosilane, chloromethyltrimethylsilane, diethyldichlorosilane, dimethoxymethylchlorosilane, dimethoxymethyl-3,3,3-trifluoropropylsilane, dimethylaminotrimethylsilane, dimethylchlorosilane, dimethyloctadecylchlorosilane, dimethylphenylchlorosilane, diphenyldichlorosilane, diphenylmethylchlorosilane, dodecyltrichlorosilane, ethoxydimethylvinylsilane, ethyldichlorosilane, ethylmethyldichlorosilane, ethynyltrimethylsilane, hexamethylcyclotrisiloxane, hydroxymethyltrimethylsilane, 3-methacryloxypropyltrimethoxysilane, methoxytrimethylsilane, methyldichlorosilane, methylethyldichlorosilane, methylvinyldichlorosilane, octadecyltrichlorosilane, octadecyltriethoxysilane, octamethylcyclotetrasiloxane, octyltrichlorosilane, phenylsilane, phenyltrichlorosilane, phenyltrimethylsilane, n-propyltrichlorosilane, trichlorosilane, triethoxyvinylsilane, triethylsilane, trifluoroacetoxytrimethylsilane, trimethylbromosilane, 1-trimethylsilyl-1,2,4-triazole, trimethylsilyl trifluoroacetate, trimethylvinylsilane, triphenylchlorosilane, triphenylsilane, triphenylsilanol, and tris(2-methoxyethoxy)vinylsilane.

Among these inactivation promoters, preferred are trimethylchlorosilane, hexamethyldisilazane, triethylchlorosilane, trimethylsilyl trifluoromethanesulfonate, N,O-bis(trimethylsilyl)acetamide, N,O-bis(trimethylsilyl)trifluoroacetamide, tert-butyldimethylchlorosilane, and N,N-bis(trimethylsilyl)urea. These inactivation promoters may be used singly or in combination.

Preferably, a mixing promoter missible with both the inactivation promoter and the supercritical fluid is added into the supercritical fluid in advance, from the viewpoint of increasing solubility in the supercritical fluid of the inactivation promoter. The mixing promoter is an organic solvent, and examples of the mixing promoter include alcohols, ketones, and amides.

Examples of such alcohols include methanol, ethanol, n-propanol, isopropanol, n-butanol, isobutanol, sec-butanol, t-butanol, n-pentanol, isopentanol, 2-methylbutanol, sec-pentanol, t-pentanol, 3-methoxybutanol, n-hexanol, 2-methylpentanol, sec-hexanol, and 2-ethylbutanol.

Examples of such ketones include acetone, methylethyl ketone, methyl-n-propyl ketone, methyl-n-butyl ketone, diethyl ketone, methyl-1-butyl ketone, methyl-n-pentyl ketone, ethyl-n-butyl ketone, methyl-n-hexyl ketone, and di-1-butyl ketone.

Examples of amides include formamide, N-methylformamide, N,N-dimethylformamide, N-ethylformamide, N,N-diethylformamide, acetamide, N-methylacetamide, N,N-dimethylacetamide, N-ethylacetamide, N,N-diethylacetamide, N-methylpropionamide, and N-methylpyrrolidone.

As for the contents in the mixture of the supercritical fluid, the inactivation promoter, and the mixing promoter, an inactivation promoter content excessively lower than the mixing promoter content degrades the inactivating effect. In contrast, an excessively higher inactivation promoter content makes it difficult to dissolve in the supercritical fluid. Therefore, the mixing promoter content is appropriately set so as not to degrade the inactivating effect of the inactivation promoter and so as to allow the inactivation promoter to dissolve in the supercritical fluid. The inactivation promoter content is preferably in the range of 0.1% to 50% by volume relative to the mixing promoter content, more preferably in the range of 0.5% to 30% by volume.

A method according to a modification of the first embodiment will be described below. This method also includes the following three steps: (1) the primary material forming step of preparing a primary material containing a matrix precursor forming the matrix of the porous material and a porogen for forming pores; (2) the removal step of removing the porogen from the primary material to form reactive sites exposed at the surface of the matrix; and (3) the inactivation step of reacting the reactive sites with an inactivation promoter to inactivate the active sites. In the method, the steps (2) and (3) are performed in parallel. In the method of the modification also, the reactive sites of the matrix are preferably reacted with the inactivation promoter by derivatization, Since, in the method of the modification, the removal step and the inactivation step are performed in parallel, the reactive sites formed by removing the porogen by extraction can be immediately inactivated.

In order to extract the porogen and inactivate the reactive sites simultaneously, a supercritical fluid containing the inactivation promoter is used. In order to increase the solubility in the supercritical fluid of the inactivation promoter, it is preferable that the mixing promoter is dissolved in the supercritical fluid, as described above.

In the primary material forming step of the first embodiment, including the modification, the porogen and the matrix precursor are dissolved in water and/or an alcohol to prepare a viscous solution, and the viscous solution is applied onto a substrate, such as a glass or metal plate. The porogen and the matrix precursor used for the primary material will now be described in detail.

The porogen is preferably a surfactant. The use of surfactant allows the formation of a micelle in the matrix precursor, and the micelle serves as a pore source to form regularly arranged pores. Nonionic or cationic surfactants can be used as the surfactant.

The nonionic surfactant may be, for example, an ethylene oxide derivative or a propylene oxide derivative.

Examples of the nonionic surfactant include polyoxyethylene decyl ether, polyoxyethylene lauryl ether, polyoxyethylene cetyl ether, polyoxyethylene olein ether, polyoxyethylene coconut alcohol ether, polyoxyethylene refined coconut alcohol ether, polyoxyethylene 2-ethylhexyl ether, polyoxyethylene synthetic alcohol ether, polyoxyethylene sec-alcohol ether, polyoxyethylene tridecyl ether, polyoxyethylene isostearyl ether, polyoxyethylene long-chain alkyl ether, polyoxyethylene octylphenyl ether, polyoxyethylene nonylphenyl ether, polyoxyethylene dodecylphenyl ether, polyoxyethylene diphenyl ether, polyoxyethylene styrenated phenyl ether, polyoxyethylene phenyl ether, polyoxyethylene benzyl ether, polyoxyethylene β-naphthyl ether, polyoxyethylene bisphenyl A ether, polyoxyethylene bisphenyl F ether, polyoxyethylene laurylamine, polyoxyethylene tallow amine, polyoxyethylene stearylamine, polyoxyethylene oleylamine, polyoxyethylene tallow propylenediamine, polyoxyethylene stearylpropylenediamine, polyoxyethylene N-cyclohexylamine, polyoxyethylene meta-xylenediamine, polyoxyethylene oleylamide, polyoxyethylene stearylamide, polyoxyethylene castor oil, polyoxyethylene hydrogenated castor oil, polyoxyethylene monolaurate, polyoxyethylerie monostearate, polyoxyethylene monotallow oleate, polyoxyethylene monotolloil fatty acid monoester, polyoxyethylene distearate, polyoxyethylene rosin ester, polyoxyethylene wool grease ether, polyoxyethylene lanolin ether, polyoxyethylene lanolin alcohol ether, polyoxyethylene polyethylene glycol, polyoxyethylene glycerol ether, polyoxyethylene trimethylolpropane ether, polyoxyethylene sorbitol ether, polyoxyethylene pentaerythritol dioleate ether, polyoxyethylene sorbitan monostearate ether, polyoxyethylene sorbitan monooleate ether, polyoxyethylene polyoxypropylene glycol, polyoxyethylene polyoxypropylene 2-ethylhexyl ether, polyoxyethylene polyoxypropylene isodecyl ether, polyoxyethylene polyoxypropylene synthetic alcohol ether, polyoxyethylene polyoxypropylene tridecyl ether, polyoxyethylene polyoxypropylene nonylphenyl ether, polyoxyethylene polyoxypropylene styrenated phenyl ether, polyoxyethylene polyoxypropylene laurylamine, polyoxyethylene polyoxypropylene tallow amine, polyoxyethylene polyoxypropylene isodecyl ether, polyoxyethylene polyoxypropylene tridecyl ether, polyoxyethylene polyoxypropylene lauryl ether, polyoxyethylene polyoxypropylene stearyl ether, polyoxyethylene polyoxypropylene glyceryl ether, polyoxypropylene 2-ethylhexyl ether, polyoxypropylene synthetic alcohol ether, polyoxypropylene butyl ether, polyoxypropylene bisphenyl A ether, polyoxypropylene styrenated phenyl ether, and polyoxypropylene meta-xylenediamine. These surfactants may be used singly or in combination.

The cationic surfactant may be a quaternary alkylammonium salt with an alkyl group having a carbon number in the range of 8 to 24, such as CₙH₂ₙ₊₁(CH₃)₃N⁺X⁻, CₙH₂ₙ₊₁(C₂H₅)₃N⁺X⁻, C₁₁H₂ₙ₊₁NH₂′ and H₂N(CH₂)ₙNH₂, wherein X represents an anionic atom.

Examples of the cationic surfactant include dodecyltrimethylammonium chloride, tetradecanyl trimethylammonium chloride, hexadecyltrimethylammonium chloride, octadecyltrimethylammonium chloride, dodecyltrimethylammonium chloride, tetradecyltrimethylammonium bromide, hexadecyltrimethylammonium bromide, octadecyltrimethylammonium bromide, dodecyltriethylammonium chloride, tetradecyltriethylammonium chloride, hexadecyltriethylammonium chloride, octadecyltriethylammonium chloride, dodecyltriethylammonium bromide, tetradecyltriethylammonium bromide, hexadecyltriethylammonium bromide, and octadecyltriethyammonium bromide.

A so-called Gemini surfactant, which has a plurality of hydrophilic groups and hydrophobic groups in its molecule, such as CₙH₂ₙ₊₁X₂N^{+M}⁻(CH₃)₃N⁺M⁻X₂CₘH₂ₘ₊₁, may be used as the surfactant. In the formula, m and n represents integers in the range of 5 to 20; s, an integer in the range of 1 to 10. X represents a hydrogen atom or an anion easily forming a salt (for example, Cl⁻ or Br⁻); M, a hydrogen atom or a lower alkyl group (for example, CH₃ or C₂H₅).

More specifically, such Gemini surfactants include C₁₂H₂₅(CH₃)₂N⁺Cl⁻(CH₃)₄N⁺Cl⁻(CH₃)₂Cl₂H, C₁₂H₂₅(CH₃)₂N⁺Br⁻(CH₃)₄N⁺Br⁻(CH₃)₂Cl₂H₂₅, C₁₆H₃₃(CH₃)₂N⁺Cl⁻(CH₃)₂N⁺Cl⁻(CH₃)₂C₁₆H₁₃, and C₁₆H₃₃(CH₃)₂N⁺Br⁻(CH₃)₄N³⁰ Br⁻(CH₃)₂C₁₆H₃₃.

Examples of the matrix precursor include oxides of titanium, silicon, aluminium, boron, germanium, lanthanum, magnesium, niobium, phosphorus, tantalum, tin, vanadium, and zirconium. Alkoxides of these metals are particularly preferable because of their superior compatibility with the porogen. Also, silica-based materials are suitable because of their low dielectric constant.

Exemplary metal alkoxides include tetraethoxytitanium, tetraisopropoxytitanium, tetramethoxytitanium, tetra-n-butoxytitanium, tetraethoxysilane, tetraisopropoxysilane, tetramethoxysilane, tetra-n-butoxysilane, triethoxyfluorosilane, trimethoxysilane, triisopropoxyfluorosilane, trimethoxyfluorosilane, trimethoxysilane, tri-n-butoxyfluorosilane, tri-n-propoxyfluorosilane, trimethylmethoxysilane, trimethylethoxysilane, trimethylchlorosilane, phenyltriethoxysilane, phenyldiethoxychlorosilane, methyltrimethoxysilane, methyltriethoxysilane, ethyltriethoxysilane, dimethyldimethoxysilane, dimethyldiethoxysilane, trismethoxyethoxyvinylsilane, triethoxyaluminium, triisobutoxyaluminium, triisopropoxyaluminium, trimethoxyaluminium, tri-n-butoxyaluminium, tri-n-propoxyaluminium, tri-sec-butoxyaluminium, tri-tert-butoxyaluminium, triethoxyboron, triisobutoxyboron, triisopropoxyboron, trimethoxyboron, tri-n-butoxyboron, tri-sec-butoxyboron, tetraethoxygermanium, tetraisopropoxygermanium, tetramethoxygermanium, tetra-n-butoxygermanium, trismethoxyethoxylanthanum, bismethoxyethoxymagnesium, pentaethoxyniobium, pentaisopropoxyniobium, pentamethoxyniobium, penta-n-butoxyniobium, penta-n-propoxyniobium, triethylphosphate, triethylphosphite, triisopropoxyphosphate, triisopropoxyphosphite, trimethylphosphate, trimethylphosphite, tri-n-butylphosphate, tri-n-butylphosphite, tri-n-propylphosphate, tri-n-propylphosphite, pentaethoxytantalum, pentaisopropoxytantalum, pentamethoxytantalum, tetra-tert-butoxytin, tin acetate, triisopropoxy-n-butyltin, triethoxyvanadyl, tri-n-propoxyoxyvanadyl, vanadium trisacetylacetonate, tetraisopropoxyzirconium, tetra-n-butoxyzirconium, and tetra-tert-butoxyzirconium. Among these alkoxides preferred are tetraisopropoxytitanium, tetra-n-butoxytitanium, tetraethoxysilane, tetraisopropoxysilane, tetramethoxysilane, tetra-n-butoxysilane, triisobutoxyaluminium, and triisopropoxyaluminium. These metal alkoxides may be used singly or in combination.

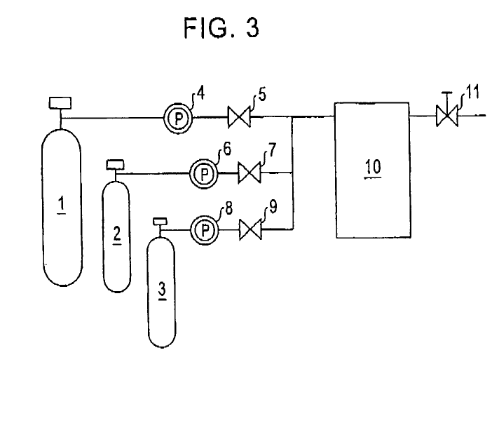

A removing and inactivating apparatus for performing the removal step and the inactivation step of the first embodiment will now be described with reference to FIG. 3.

The removing and inactivating apparatus includes: a carbon dioxide cylinder 1 containing carbon dioxide, which is a primary constituent of the supercritical fluid; a first chemical cylinder 2 containing, for example, an alkyl alcohol; and a second chemical cylinder 3 containing a mixed solution of, for example, an alkyl alcohol and an inactivation promoter. The carbon dioxide cylinder 1, the first chemical cylinder 2, and the second chemical cylinder 3 are connected to a high-pressure container 10 through pumps 4, 6, and 9 and switching valves 5, 7, and 9, respectively. A heater (not shown in the figure) is provided downstream from the pumps 4, 6, and 8, if necessary. In addition, a regulating valve 11 for adjusting the pressure in the high-pressure container is provided in a line downstream from the high-pressure container 10.

The apparatus is used as follows. A substrate onto which the primary material is applied is placed in the high-pressure container 10. Then, carbon dioxide heated to an appropriate temperature is introduced to the high-pressure container 10, and the pressure in the high-pressure container 10 is adjusted with the regulating valve 11 so as to create a supercritical state. Then, the alkyl alcohol is introduced to the container 10 from the first chemical cylinder 2 to mix it with the supercritical fluid. Thus, the porogen is removed from the primary material by extraction. Then, after the introduction of the alcohol from the first chemical cylinder 2 is stopped, the alkyl alcohol containing the inactivation promoter is introduced into the high-pressure container 10 from the second chemical cylinder 3. Thus, the primary material is treated with the supercritical fluid containing the inactivation promoter so that the reactive sites at the surface of the matrix defining the pores are reacted with the inactivation promoter to be inactivated. After the introductions from the carbon dioxide cylinder 1 and the second chemical cylinder 3 are stopped to reduce the pressure of the high-pressure container 10, the substrate is taken out.

Alternatively, the alkyl alcohol containing the inactivation promoter in the second chemical cylinder 3 may be introduced into the high-pressure container 10 to mix it with the carbon dioxide supercritical fluid during the removal of the porogen. Thus, the mixture of the supercritical fluid, the alkyl alcohol, and the inactivation promoter removes the porogen and simultaneously inactivates the reactive sites at the surface of the matrix.

A second embodiment will now be described. A method for producing a porous material according to the second embodiment includes the following three steps: (1) the primary material forming step of forming a primary material including a matrix formed of a primary matrix of the porous material and a pore-forming portions formed of a porogen; (2) the matrix precursor addition step of supplying an additional matrix precursor dissolved in a supercritical fluid or a subcritical fluid to the primary material; and (3) the removal step of removing the porogen from the pore-forming portions of the primary material with a supercritical fluid or a subcritical fluid.

The removal step of the present embodiment preferably uses a highly permeable supercritical or subcritical fluid, as in the first embodiment. The supercritical or subcritical fluid used in the matrix precursor addition step can be continuously used in the removal step, thus enhancing the treatment ability. Preferably, the supercritical or subcritical fluid mainly contains carbon dioxide and/or at least one alkyl alcohol, which easily create a supercritical state at a temperature of about 150° C. or less, preferably 100° C. or less, and which are missible with various types of material.

In the primary material forming step, the matrix precursor and the porogen are dissolved in water and/or an alcohol to prepare a viscous solution, and the viscous solution is applied onto a substrate, such as a glass or metal plate. The primary material forming step allows the matrix precursor to form a matrix of the porous material, and the porogen to form pore-forming portions. The matrix itself is microscopically porous, having an infinite number of microscopic pores. The porogen and the matrix precursor used for the primary material will now be described in detail.

The porogen is preferably a surfactant. The use of surfactant allows the formation of a micelle in the matrix precursor, and the micelle serves as a pore source to form regularly arranged pores. Nonionic or cationic surfactants are used as the surfactant.

The nonionic surfactant may be, for example, an ethylene oxide derivative or a propylene oxide derivative. Specifically, the same nonionic surfactants listed in the first embodiment can be used.

The cationic surfactant can also be selected from the cationic surfactants listed in the first embodiment.

A so-called Gemini surfactant, which has a plurality of hydrophilic groups and hydrophobic groups in its molecule, may be used as the surfactant. Specifically, the same Gemini surfactants listed in the first embodiment can be used.

The matrix precursor of the primary material is preferably an inorganic material from the viewpoint of thermal stability, workability, and mechanical strength. Examples of the matrix precursor include oxides of titanium, silicon, aluminium, boron, germanium, lanthanum, magnesium, niobium, phosphorus, tantalum, tin, vanadium, and zirconium. Alkoxides of these metals are particularly preferable because of their reactivity, and superior compatibility with the porogen. Also, silica-based materials are suitable because of their low dielectric constant.

The metal alkoxides listed in the first embodiment can be used as the matrix precursor.

In order to increase the density of the matrix, an additional or additional matrix precursor dissolved in a supercritical or subcritical fluid is added to the primary material in the matrix precursor addition step. The additional matrix precursor preferably has a functional group reactive with the surface of the matrix in the primary material and an atomic bond forming the matrix of the porous material. The additional matrix precursor can easily bond to the surfaces defining the microscopic pores in the matrix itself, and fill the pores. The functional group of the additional matrix precursor is preferably a reactive alkoxy group. Such a compound containing an alkoxy group can be selected from the metal alkoxides listed in the first embodiment.

Compounds less reactive than metal alkoxide may be used as the additional matrix precursor. Such compounds includes vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, 3-(2-aminoethylaminopropyl)trimethoxysilane, 3-aminopropyltriethoxysilane, 3-chloropropyltrimethoxysilane, 3-aminopropyltrimethoxysilane, N-2(aminoethyl)-3-aminopropylmethyldimethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-trichloropropyltrimethoxysilane, 3-mercaptopropylmethyldimethoxysilane, 3-mercaptopropyltrimethoxysilane, bis(triethoxysilylpropyl)tetrasulfide, 3-isocyanatepropyltriethoxysilane, trimethylmethoxysilane, trimethylethoxysilane, trimethylmethoxysilane, triethylethoxysilane, dimethyldimethoxysilane, dimethyldiethoxysilane, diethyldimethoxysilane, diethyldiethoxysilane, diphenyldimethoxysilane, diphenyldiethoxysilane, methyltrimethoxysilane, methyltriethoxysilane, ethyltrimethoxysilane, ethyltriethoxysilane, phenyltrimethoxysilane, phenyltriethoxysilane, hexyltrimethoxysilane, hexyltriethoxysilane, decyltrimethoxysilane, decyltriethoxysilane, 3,3,3-trifluoropropyltrimethoxysilane, heptadecatrifluorodecyltrimethoxysilane, fluorooctylethyltrimethoxysilane, allyltriethoxysilane, dimethoxymethylchlorosilane, dimethoxymethyl-3,3,3-trifluoropropylsilane, 3-methacryloxypropyltrimethoxysilane, methoxytrimethylsilane, octadecyltriethoxysilane, and triethoxyvinylsilane.

Preferably, the additional matrix precursor is mixed with a supercritical or subcritical fluid together with a mixing promoter missible with both the matrix precursor and the supercritical or subcritical fluid. It is particularly effective to use a supercritical or subcritical fluid mainly containing carbon dioxide, which is relatively immissible with polar compounds. In this instance, the solution of the additional matrix precursor in the mixing promoter is used in a volume of about 1/20 to ⅕ relative to the volume of supercritical or subcritical fluid. The proportion of the additional matrix precursor to the mixing promoter is appropriately set in such a range the matrix precursor is evenly blended into the supercritical or subcritical fluid without adversely affecting the ability of the matrix precursor. The additional matrix precursor content is preferably in the range of 0.1% to 50% by volume relative to the mixing promoter content more preferably in the range of 0.5% to 30% by volume. An excessively lower matrix precursor content makes it difficult to supply the matrix precursor. In contrast, an excessively higher matrix precursor makes it difficult to blend well into the supercritical or subcritical fluid.

The mixing promoter is preferably an organic solvent missible with the supercritical or subcritical fluid and the matrix precursor. Exemplary organic solvents include alcohols, ketones, and amides. Specifically, the organic solvent is selected from the solvents listed in the first embodiment.

The organic solvent used as the mixing promoter does not necessarily have polarity in contrast to an organic solvent used for the removal step, described later. The use of a polar solvent as the mixing promoter causes removal of the porogen to form pores, and the pores are filled with the matrix precursor. Consequently, the pore size is slightly changed. In order to prevent the change in pore size, it is effective to use a less polar solvent, such as hexane, or to use a polar solvent at a low concentration. However, the matrix precursor addition step and the removal step may be simultaneously performed. In this instance, the mixing promoter can be a polar solvent (or a bellow-described removing promoter).

For the removal of the porogen in the removal step, a supercritical or subcritical fluid may be singly used. However, it is preferable to use a mixture of the supercritical or subcritical fluid and a removing promoter for promoting the removal of the porogen. Thus, the porogen, which is an organic compound, can be easily dissolved and extracted. It is particularly effective to use a supercritical or subcritical fluid mainly containing carbon dioxide, which is relatively immissible with polar compounds, such as the porogen (surfactant). The proportion of the removing promoter is about 1/20 to ⅕ to the amount of the supercritical or subcritical fluid on a volume basis.

Exemplary removing promoters include organic solvents, such as alcohols, ketones, and amides. Specifically, the organic solvent is selected from the above-listed solvents.

Among these, preferred are methanol and other highly polar organic solvents. This is because the porogen is bonded to the matrix by the polarity of its molecules, and the removing promoter needs to have a polarity higher than the polarity of the porogen in order to remove the porogen.

For performing the matrix precursor addition step and the removal step, the same apparatus as in the first embodiment, shown in FIG. 3, can be used.

The apparatus is used as follows. A substrate onto which the primary material is formed is placed in the high-pressure container 10. Then, carbon dioxide heated to a temperature of 150° C. or less, preferably 100° C. or less, is introduced to the high-pressure container 10, and the pressure in the high-pressure container 10 is adjusted with the regulating valve 11 so as to create a supercritical or subcritical state. Then, a solution containing the additional matrix precursor is introduced to the container 10 from the first chemical cylinder 2 to mix it with the supercritical or subcritical fluid. Thus, the additional matrix precursor is supplied to the primary material (matrix). After the introduction of the matrix precursor solution from the first chemical cylinder 2 is stopped and purged with the carbon dioxide supercritical or subcritical fluid, the removal promoter is introduced to the high-pressure container 10 from the second chemical cylinder 3. Thus, the porogen is removed from the primary material by extraction with the supercritical or subcritical fluid containing the removing promoter. After the introductions from the carbon dioxide cylinder 1 and the second chemical cylinder 3 are stopped to reduce the pressure of the high-pressure container 10, the substrate is taken out. Finally, the resulting porous material is heat-treated at about 200° C. or less to be stabilized, if necessary.

### EXAMPLES

The present invention will be further described with reference to examples, but the invention is not limited by the examples.

The following Examples 1 and 2 are for the first embodiment.

### Example 1

In Example 1, a primary material is formed in a film (primary material film), and then the porogen in the primary material film is removed to form pores simultaneously with the inactivation of the reactive sites at the surface of the matrix defining the pores.

Evenly blended were 1.6 g of a matrix precursor, tetraethoxysilane Si(C₂H₅O)₄, 7.8 g of ethanol, 0.7 g of water of pH 3, and 0.4 g of a porogen, hexadecyltrimethylammonium chloride to prepare a transparent and viscous solution. The solution was applied onto a substrate to form a primary material film by spin coating. The film was dried at 200° C. in a normal atmosphere, and then, the porogen hexadecyltrimethylammonium chloride was removed by supercritical extraction with the apparatus shown in FIG. 3, simultaneously with the inactivation, in the following manner.

After the substrate having the primary material film was place in the high-pressure container, carbon dioxide of 80° C. was introduced into the high-pressure container and the internal pressure of the container was increased to 15 MPa to create a supercritical state. A methanol solution containing 10% by volume of an inactivation promoter hexamethyldisilazane was introduced into the high-pressure container in the supercritical state to be evenly blended with the supercritical fluid. The volume proportion of the methanol solution was 1/10 to the volume of carbon dioxide. The high-pressure container was allowed to stand in this state for 30 minutes and the introduction of the methanol solution was stopped. Subsequently, 50 L of carbon dioxide on a gas basis was allowed to flow to purge the container completely with the carbon dioxide. Then, the pressure of the container was reduced and the substrate was taken out.

The resulting porous film was subjected to Fourier transform infrared spectroscopy (FTIR). As a result, a peak at around 2, 920 cm⁻¹ resulting from CH₂ stretching vibration, which had been observed with high intensity before the removal and inactivation treatment with use of the supercritical fluid, was not observed at all after the treatment. This suggests that the porogen hexadecyltrimethylammonium chloride was completely removed. On the other hand, peaks at around 2,860 and 2,960 cm⁻¹ resulting from CH₃ stretching vibration were observed. Thus, it has been confirmed that the surface of the silica matrix was terminated with CH₃ groups by the treatment using the supercritical fluid containing the inactivation promoter hexamethyldisilazane.

### Example 2

In Example 2, the porogen in the primary material film was removed, and subsequently the reactive sites at the surface of the matrix were inactivated.

After a viscous solution was prepared in the same manner as in Example 1, the solution was applied onto a substrate by spin coating, followed by drying at 200° C. in a normal atmosphere. Then, the porogen hexadecyltrimethylammonium chloride was removed by supercritical extraction, and subsequently inactivation was performed with the same apparatus used in Example 1, in the following manner.

After the substrate having the primary material film was place in the high-pressure container, carbon dioxide of 80° C. was introduced into the high-pressure container and the internal pressure of the container was increased to 15 MPa to create a supercritical state. Methanol was introduced into the high-pressure container in the supercritical state. The volume proportion of the methanol was 1/10 to the volume of carbon dioxide. After the container was allowed to stand in this state for 20 minutes, the introduction of methanol was stopped. Subsequently, a methanol solution containing 10% by volume of an inactivation promoter hexamethyldisilazane was introduced. The container was allowed to stand in this state for 10 minutes, and then the introduction of the methanol solution was stopped. Subsequently, 50 L of carbon dioxide on a gas basis was allowed to flow to purge the container completely with the carbon dioxide. Then, the pressure of the container was reduced and the substrate was taken out.

The resulting porous film was subjected to FTIR. As a result, a peak at around 2,920 cm⁻¹ resulting from CH₂ stretching vibration, which had been observed with high intensity before the removal and inactivation treatments, was not observed at all after the treatments. Thus, it has been confirmed that the porogen hexadecyltrimethylammonium chloride was completely removed. On the other hand, peaks at around 2,860 and 2,960 cm⁻¹ resulting from CH₃ stretching vibration were observed. Thus, it has been confirmed that the surface of the silica matrix was terminated with CH₃ groups by the inactivation with use of the supercritical fluid containing the inactivation promoter hexamethyldisilazane.

### Comparative Example 1

Comparative Example 1 is conducted in the same manner as in Example 2 except that no inactivation promoter is added to the supercritical fluid for the inactivation treatment.

A substrate onto which a primary material film had been formed in the same manner as in the foregoing examples was place in the high-pressure container. Then, carbon dioxide of 80° C. was introduced into the high-pressure container and the internal pressure of the container was increased to 15 MPa to create a supercritical state. Methanol was introduced into the high-pressure container in the supercritical state. The volume proportion of the methanol was 1/10 to the volume of carbon dioxide. The high-pressure container was allowed to stand in this state for 30 minutes and the introduction of methanol was stopped. Subsequently, 50 L of carbon dioxide on a gas basis was allowed to flow to purge the container completely with the carbon dioxide. Then, the pressure of the container was reduced and the substrate was taken out.

The resulting porous film was subjected to FTIR. As a result, a peak at around 2,920 cm⁻¹ resulting from CH₂ stretching vibration, which had been observed with high intensity before the removal and inactivation treatments, was not observed at all after the treatments. Thus, it has been confirmed that the porogen hexadecyltrimethylammonium chloride was completely removed. Also, the peaks at 2,860 and 2,960 cm⁻¹ resulting from CH₃ stretching vibration are slightly observed. Thus, it has been fond that esterification with methanol alone cannot completely terminate the surface of the silica matrix with CH₃ groups.

### Comparative Example 2

Comparative Example 2 was performed in the same manner as in Comparative Example 1 except that carbon dioxide of 40° C. was introduced into the high-pressure container. As a result, the porogen was completely removed, but the peaks resulting from CH₂ stretching vibration were not observed. Thus, it has been found that the carbon dioxide of a temperature as low as 40° C. cannot terminate the surface of the silica matrix with CH₃ at all.

The temporal stability of the porous films produced in Examples 1 and 2 and Comparative Examples 1 and 2 were evaluated from their thicknesses and the periods of their periodic structures determined by X-ray diffraction (XRD). The results are shown in Table 1. Thicknesses were measured with a spectrometric film thickness measurement system (Lambda Ace, produced by Dainippon Screen MFG. Co., Ltd.). The XRD analysis was performed with RINT-1500, produced by Rigaku Corporation, using Cu-Kα rays as the radiation source. Table 1 shows changes in thickness after a predetermined time has elapsed, expressed as a percentage relative to the thickness before the supercritical treatment, and the periods (nm) of the periodic structures after a day has elapsed. Table 1 suggests that while the porous films of the examples exhibited superior temporal stability, the porous films of the comparative examples exhibited large changes with time and were not stabilized even after one week.

TABLE 1

| | Thickness change in percent | | | | |
|---|---|---|---|---|---|
| | to thickness before | | | | Period of |
| | supercritical treatment (%) | | | | periodic structure |
| | After | After | After | After | after a day, |
| | 10 min. | 1 hour | a day | a week | (nm) |
| Example 1 | 98 | 98 | 98 | 97 | 2.9 |
| Example 2 | 98 | 98 | 97 | 97 | 2.9 |
| Comparative | 98 | 96 | 92 | 70 | 2.0 |
| Example 1 | | | | | |
| Comparative | 82 | 77 | 70 | 55 | 1.6 |
| Example 2 | | | | | |

### Example 3

The following Example 3 is for the second embodiment.

Evenly blended were 1.6 g of a matrix precursor tetraethoxysilane Si(C₂H₅O)₄, 7.8 g of ethanol, 0.7 g of water of pH 3, and 0.4 g of a porogen hexadecyltrimethylammonium chloride to prepare a transparent and viscous solution. The solution was applied onto a substrate to form a primary material in a film by spin coating. After the primary material film was heated at 100° C., an additional matrix precursor was supplied to the primary material film with the apparatus shown in FIG. 3 and the porogen was subsequently removed in the following manner.

The substrate having the primary material film was place in the high-pressure container. Carbon dioxide of 80° C. was introduced into the high-pressure container and the internal pressure of the container was increased to 15 MPa to create a supercritical state. A hexane solution containing 10% by volume of an additional matrix precursor tetraethoxysilane was introduced into the high-pressure container to blend the solution with the carbon dioxide supercritical fluid uniformly. The volume proportion of the hexane solution was 1/10 to the volume of carbon dioxide. The high-pressure container was allowed to stand in this state for 30 minutes and the introduction of the hexane solution was stopped. Subsequently, 50 L of carbon dioxide on a gas basis was allowed to flow to purge the container completely with the carbon dioxide.

Then, the porogen, hexadecyltrimethylammonium chloride was removed by supercritical extraction with the supercritical state maintained, in the following manner. Methanol was introduced into the high-pressure container with the supercritical state maintained. The high-pressure container was allowed to stand in this state for 30 minutes, and then the introduction of methanol was stopped. The volume proportion of the methanol was 1/10 to the volume of carbon dioxide. Subsequently, 50 L of carbon dioxide on a gas basis was allowed to flow to purge the container completely with the carbon dioxide. Then, the pressure of the container was reduced and the substrate was taken out.

The resulting porous film was subjected to FTIR. As a result, a peak at around 2,920 cm⁻¹ resulting from CH₂ stretching vibration, which had been observed with high intensity before the supercritical treatment, was not observed at all after the treatment. This suggests that the porogen hexadecyltrimethylammonium chloride was completely removed.

The thickness of the porous film was measured and compared with the thickness of the primary material film before the supercritical treatment. The percentage of the thickness after the treatment was 97% relative to the thickness of the primary material film. Furthermore, the porous film was heat-treated at 200° C., and the thickness after the heat treatment was 94% relative to the thickness of the primary material film. These thicknesses were measured with a spectrometric film thickness measurement system (Lambda Ace, produced by Dainippon Screen MFG. Co., Ltd.).

For comparison, a porous film was prepared in the same manner as in Example 3 except that the additional matrix precursor tetraethoxysilane was not supplied, but only a hexane solution was introduced. The resulting porous film was subjected to FTIR, and it was confirmed that the porogen was completely removed. However, the result of thickness measurement showed that the thickness was reduced to 60% relative to the thickness of the primary material film before the supercritical treatment. Also, the thickness of the porous film subjected to heat treatment at 200° C. was reduced to 52% relative to the thickness of the primary material film.

1. A method for producing a porous material, comprising:
the primary material forming step of forming a primary material containing a matrix precursor forming a matrix of the porous material and a porogen for forming pores;
the removal step of removing the porogen from the primary material to form pores, thereby exposing reactive sites at the surface of the matrix; and
the inactivation step of reacting the reactive sites with an inactivation promoter to inactivate the reactive sites, the inactivation promoter comprising a compound having a functional group reactive with the reactive sites of the matrix and a functional group unreactive with the reactive sites of the matrix.

2. The method according to claim 1, wherein the inactivation step is performed after the removal step is completely performed on the entire primary material.

3. The method according to claim 1, wherein the inactivation promoter is supplied to the primary material to start the inactivation step before the removal step is completed for the entire primary material.

4. The method according to claim 1, wherein the reaction between the reactive sites and the inactivation promoter is performed by derivatization.

5. The method according to claim 1, wherein the removal step uses a supercritical fluid to remove the porogen, and the inactivation step is performed by a mixture of the supercritical fluid and the inactivation promoter.

6. The method according to claim 5, wherein the mixture further contains a mixing promoter missible with the inactivation promoter and the supercritical fluid.

7. The method according to claim 6, wherein the inactivation promoter content in the mixture is 50% by volume relative to the mixing promoter content.

8. The method according to claim 1, wherein the porogen comprises a surfactant.

9. The method according to claim 1, wherein the matrix precursor mainly contains silica.

10. The method according to claim 1, wherein the unreactive functional group is a hydrophobic group.

11. A method for producing a porous material, comprising the steps of:
the primary material forming step of forming a primary material comprising a matrix formed of a matrix precursor and a pore-forming portions formed of a porogen;
the matrix precursor addition step of supplying additional matrix precursor for growing the matrix, the additional matrix precursor dissolved in one fluid of a supercritical fluid and a subcritical fluid, the additional matrix precursor having a functional group reactive with the surface of the matrix and an atomic bond forming the matrix; and
the removal step of removing the porogen from the pore-forming portions.

12. The method according to claim 11, wherein the removal step is performed in one fluid of a supercritical fluid and a subcritical fluid.

13. The method according to claim 12, wherein the fluid contains a removing promoter for promoting the removal of the porogen.

14. The method according to claim 11, wherein the fluid containing the additional matrix precursor further contains a mixing promoter missible with the additional matrix precursor and the fluid.

15. The method according to claim 14, wherein the additional matrix precursor content in the fluid is 50% by volume relative to the mixing promoter.

16. The method according to claim 11, wherein the porogen comprises a surfactant.

17. The method according to claim 11, wherein the matrix precursor and the additional matrix precursor mainly contain silica.

18. The method according to claim 11, wherein the functional group reactive with the surface of the matrix is an alkoxy group.

19. The method according to claim 18, wherein the additional matrix precursor comprises a metal alkoxide.
